(19) United States
(12) Patent Application Publication
(10) Pub. No.: US 2015/0279047 A1
(43) Pub. Date: Oct. 1, 2015

(54) EXEMPLAR-BASED COLOR CLASSIFICATION

(71) Applicant: QUALCOMM INCORPORATED, San Diego, CA (US)

(72) Inventors: Zeeshan ZIA, London (GB); Emilio MAGGIO, Vienna (AT); Qi PAN, Vienna (AT); Michael GERVAUTZ, Vienna (AT); Zsolt SZALAVARI, Vienna (AT)

(21) Appl. No.: 14/538,732

(22) Filed: Nov. 11, 2014

Related U.S. Application Data
(60) Provisional application No. 61/971,487, filed on Mar. 27, 2014.

(51) Int. Cl. G06T 7/00; G06T 7/40

(52) U.S. Cl. CPC G06T 7/0079; G06T 7/408; G06T 2207/10024

(57) ABSTRACT

Disclosed is a method and apparatus for exemplars-based color classification. In one embodiment, the functions implemented include: processing an image captured by a camera to identify a first color profile that most closely matches colors of the image, wherein the first color profile is selected from a plurality of color profiles each color profile encoding data related to how two or more component colors appear under a different lighting condition.

### CROSS REFERENCE TO RELATED APPLICATIONS

The present application claims priority to U.S. Provisional Patent Application No. 61/971,487, filed Mar. 27, 2014, entitled “Component-Based Target Object Detection and Color Classification,” the content of which is hereby incorporated by reference in its entirety for all purposes.

### FIELD

The present disclosure relates generally to color analysis and classification. Various embodiments are related to exemplar-based color classification.

### BACKGROUND

Recognizing and classifying component colors of a physical object captured in an image is not a trivial task even when the number of component colors is limited and all the component colors are known, because each particular component color may have vastly different appearances (for example, colors) in images captured under different lighting or illumination conditions.

For example, a white component color on a physical object under a first lighting condition may appear the same as, or even more yellow on an absolute color palette than, a yellow component color on the physical object under a second lighting condition.

### SUMMARY

An embodiment disclosed herein may include a method for exemplars-based color classification, comprising: processing an image captured by a camera to identify a first color profile that most closely matches colors of the image, wherein the first color profile is selected from a plurality of color profiles, each color profile encoding data related to how two or more component colors appear under a different lighting condition.

Another embodiment disclosed herein may include an apparatus adapted for exemplars-based color classification, comprising: a memory; and a processor configured to: process an image captured by a camera to identify a first color profile that most closely matches colors of the image, wherein the first color profile is selected from a plurality of color profiles, each color profile encoding data related to how two or more component colors appear under a different lighting condition.

A further embodiment disclosed herein may include an apparatus adapted for exemplars-based color classification, comprising: means for processing an image captured by a camera to identify a first color profile that most closely matches colors of the image, wherein the first color profile is selected from a plurality of color profiles, each color profile encoding data related to how two or more component colors appear under a different lighting condition.

An additional embodiment disclosed herein may include a non-transitory computer-readable medium including code which, when executed by a processor, causes the processor to perform a method comprising: processing an image captured by a camera to identify a first color profile that most closely matches colors of the image, wherein the first color profile is selected from a plurality of color profiles each color profile encoding data related to how two or more component colors appear under a different lighting condition.

### BRIEF DESCRIPTION OF THE DRAWINGS

FIG. 1 illustrates one embodiment of a device that may be used as part of various embodiments described herein.

FIG. 2 illustrates three images of a same physical training object comprising six component colors captured under different lighting conditions.

FIG. 3 illustrates appearances of an exemplary white component color under different lighting conditions.

FIG. 4 illustrates an exemplary color wheel with five colors from a particular color profile charted on the wheel.

FIG. 5A is a flowchart illustrating an exemplary method for analyzing a target object with color classification as described herein.

FIG. 5B is a flowchart illustrating an exemplary method for analyzing a target object with color classification as described herein.

FIG. 6 is a flowchart illustrating an exemplary method for determining a color profile from the training process that most closely matches a particular image.

### DETAILED DESCRIPTION

Embodiments described herein relate to color analysis and classification. Certain embodiments specifically relate to classification of colors of foreground pixels representing a physical object with a finite set of known component colors in an image. Each component color and its associated appearances may be referred to as a color class.

Embodiments of the disclosure are related to per-pixel color processing to identify a color profile that matches the colors present in an image of a target physical object. A training object containing all the same component colors as those of the target objects may be constructed. Preferably the training object should be built such that segmentation of pixels associated with the training object in an image of the training object according to pixel colors is easy to perform, either manually or automatically. For example, component colors on the training object may be contained in single-color color blocks that have simple shapes and boundaries.

A plurality of colors profiles may be created based on a plurality of images of the training object taken under different lighting conditions. Each color profile may be associated with a particular lighting condition. The color profiles may contain information relating to how the component colors appear under particular lighting conditions.

When colors of foreground pixels representing the target physical object in an image are to be recognized and classified into color classes, a single color profile that most closely matches the lighting condition, and therefore the colors of the image is first found, and thereafter colors of foreground pixels may be classified based on the color profile.

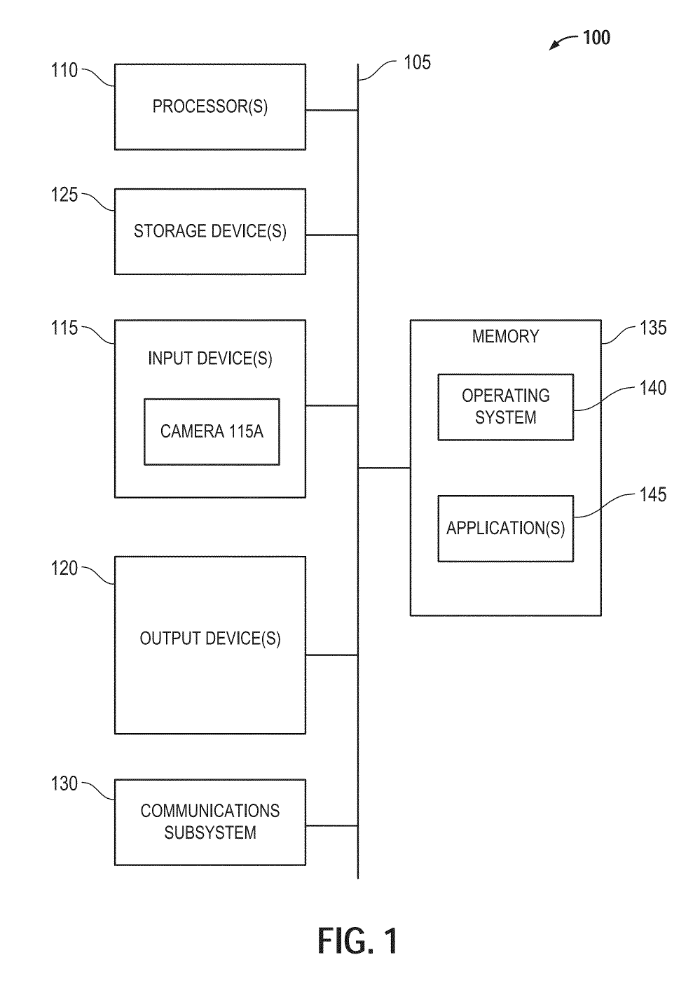

An example device 100 adapted for exemplar-based color classification is illustrated in FIG. 1. The device as used herein may be a: mobile device, wireless device, cell phone, personal digital assistant, mobile computer, wearable device (e.g., watch, head mounted display, virtual reality glasses, etc.), tablet, personal computer, laptop computer, or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, the device 100 may include a radio device, a cellular telephone device, a computing device, a personal communication system device, or other like movable wireless communication equipped device, appliance, or machine.

The device 100 is shown comprising hardware elements that can be electrically coupled via a bus 105 (or may otherwise be in communication, as appropriate). The hardware elements may include one or more processor(s) 110, including without limitation one or more general-purpose processors and/or one or more special-purpose processors (such as digital signal processing chips, graphics acceleration processors, and/or the like); one or more input devices 115, which include a camera 115A, and further include without limitation a mouse, a keyboard, keypad, touch-screen, camera, microphone and/or the like; and one or more output devices 120, which include without limitation a display device, a speaker, a printer, and/or the like.

The device 100 may further include (and/or be in communication with) one or more non-transitory storage devices 125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The device may also include a communications subsystem 130, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other devices, and/or any other devices described herein. In one embodiment, the device 100 may further comprise a memory 135, which can include a RAM or ROM device, as described above. It should be appreciated that device 100 may be a mobile device or a non-mobile device, and may have wireless and/or wired connections.

The device 100 may also comprise software elements, shown as being currently located within the working memory 135, including an operating system 140, device drivers, executable libraries, and/or other code, such as one or more application programs 145, which may comprise or may be designed to implement methods, and/or configure systems, provided by embodiments, as will be described herein. Merely by way of example, one or more procedures described with respect to the method(s) discussed below might be implemented as code and/or instructions executable by device 100 (and/or a processor(s) 110 within device 100); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 125 described above. In some cases, the storage medium might be incorporated within a device, such as the device 100. In other embodiments, the storage medium might be separate from a device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computerized device 100 and/or might take the form of source and/or installable code, which, upon compilation and/or installation on the device 100 (e.g., using any of a variety of generally available compilers, installation programs, compression/decompression utilities, etc.), then takes the form of executable code.

Application programs 145 may include one or more applications adapted for exemplars-based color classification. It should be appreciated that the functionality of the applications may be alternatively implemented in hardware or different levels of software, such as an operating system (OS), a firmware, a computer vision module, etc.

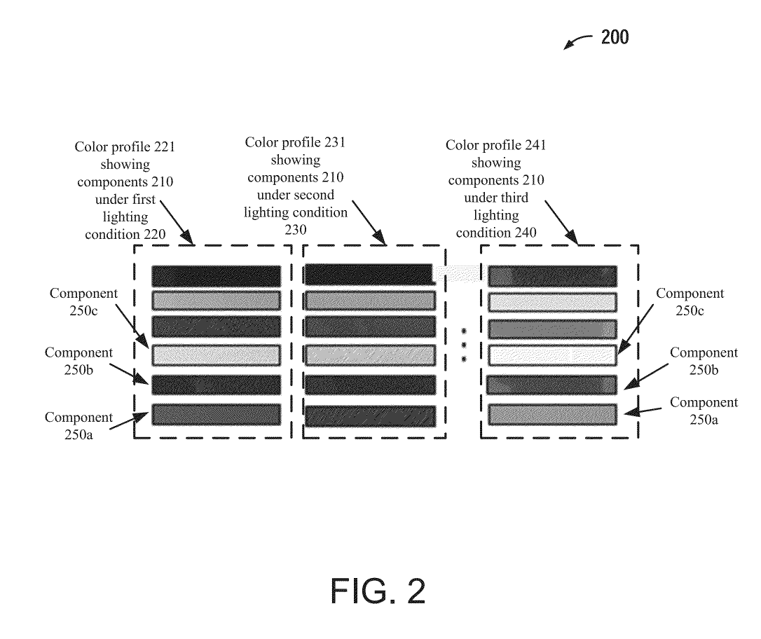

FIG. 2 illustrates three images of a same physical training object comprising six component colors captured under different lighting conditions. FIG. 2 may be considered as showing a training object under three different lighting conditions, which may be used to create three color profiles 221, 231, and 241. Six sets of components are depicted for three lighting conditions, shown as lighting conditions 220, 230, and 240. The physical components each having a component color which may differ from each other, which include identified component colors 250 (three of the identified component colors 250, 250a-c, are indicated in FIG. 2), are the same components with the same component colors 250 in all three lighting conditions 220, 230, 240, but the colors captured by a camera, such as camera 115A, as part of an image will be different due to the lighting conditions. Color profiles 221, 231, and 241 thus encode the color appearances of the training object having multiple component colors 250 under different specific lighting conditions 220, 230, and 240. The color profiles may model both single color class changes under different lighting situations, and the relative changes across colors as lighting conditions change. Moreover, because the illumination of the training object under a particular lighting condition may not be uniform, a single color class (comprising apparent colors of a single color component) may comprise multiple colors under a same uneven lighting condition. Therefore, in some embodiments, all color appearances for each single color class may be included in the color profiles. Additionally or alternatively, each single color class under a particular lighting condition may be represented in the respective color profile with, for example, a mean color. Color profiles may also include covariance measurements of color appearances across different color classes. In other words, as the incident light on a target object with multiple color components changes, the variations in perceived color from different colored components will be related and will change together in a predictable fashion, even if this relative change is complex and non-linear.

Information associated with FIG. 2 may be captured as part of a system training, where a training object that includes a limited number of colors comprising the plurality of colors for a system is built. The target physical object can potentially contain the same finite set of colors as the training object. In other words, system can classify colors in components of the target physical object, but only if the colors of the components of the target physical object are included in the training object.

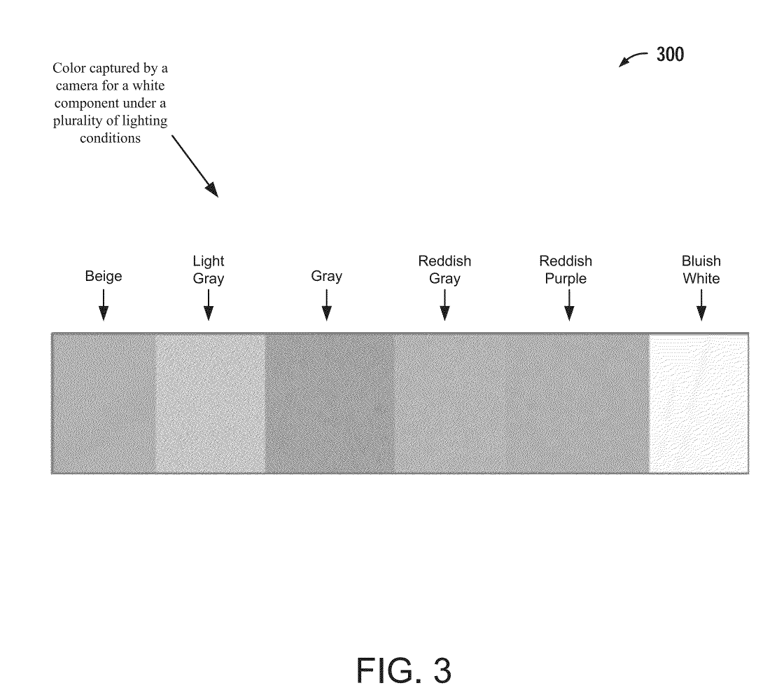

FIG. 3 illustrates appearances of an exemplary white component color under different lighting conditions. As can be seen in FIG. 3, six different colors are captured for a white component color of a training object under different lighting conditions. In this case, the white component shows beige, gray, purple, etc. variations. Due to these variations there can be significant overlap between the possible pixel color values of different color classes under different lighting conditions. In certain circumstances, this may cause difficulty in distinguishing, for example, white components from colored components.

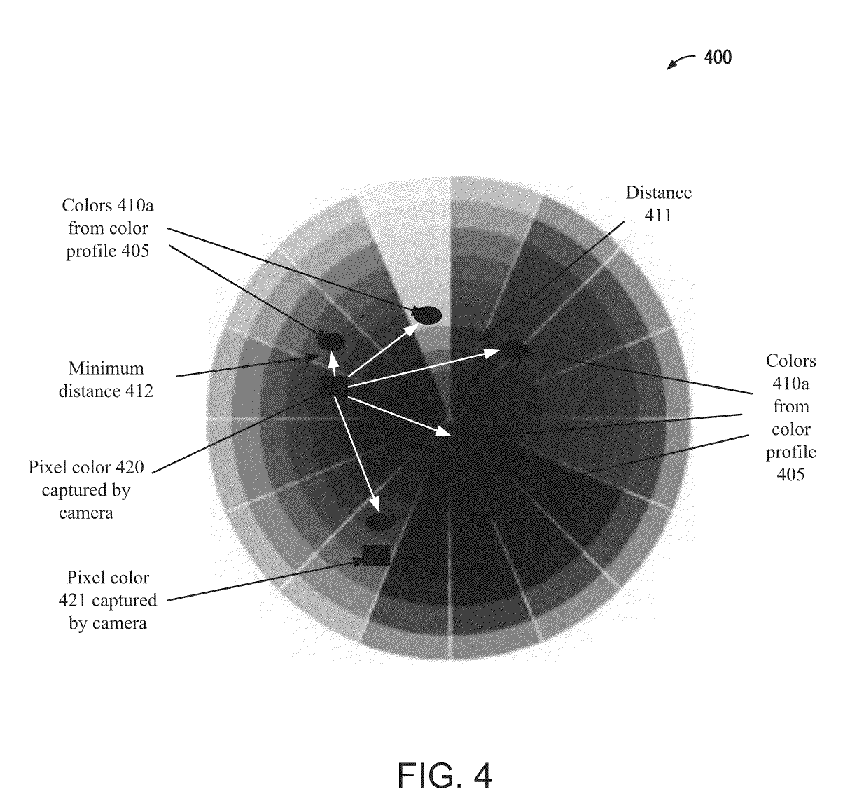

FIG. 4 illustrates an exemplary color wheel 400 with five colors 410a from a particular color profile 405 charted on the wheel. Colors 410a of color profile 405 may be, for example, mean colors of the five color classes under a single lighting condition. Of course, the positions of the colors for different color profiles would be different on the color wheel 400. For example, a color profile from a brighter incident lighting environment would be expected to show the associated colors shifted toward the outside of the color wheel shown. A model from a darker illumination situation would shift the colors toward the center of the color landscape. A black object would be associated with a dark color near the center of the color landscape, and the associated color in a color model would not be expected to shift dramatically under different lighting environments, while a white object would be associated with colors that may vary all over the shown color landscape depending on the color of the incident light.

Pixel colors 420 and 421 represent a charting of the colors of two pixels captured as part of an image. A best match to the pixel colors may be identified by determining a distance 411 from each charted pixel color to each color of color profile 405. The best match between pixel color 420 and colors 410a of color profile 405 is shown as minimum distance 412. This identifies the green color of color profile 405 as the closest match to the color of a pixel associated with pixel color 420. If this process is repeated for every pixel of an image, or of a target physical object, and every color profile within a system, and the resultant minimum distances aggregated, the best color profile match for the entire image, or of the target physical object, may be found. Once a best color profile match has been identified, the lightening condition may then be estimated or assumed based on the color profile and the colors in the image may then be classified based on the assumed lightening condition. Further, in some embodiments, instead of individual pixels, the operations described herein may be applied to groups of pixels (pixel groups), such as groups of pixels that have been spatially segmented before performing the distance measurements described herein. It should be appreciated that the distance on the color wheel 400 is but one possible way to measure differences (alternatively conceivable as costs) between different colors. The disclosure is not limited by the method used to determine color differences, and other measurements of color differences may be utilized.

In various embodiments then, a training object may be used to create a plurality of color profiles. The training object may be captured under a plurality of lighting conditions and used to create a plurality of training images. The colors from the training images may be used to create color profiles. The color profiles thus may capture the relationship between the captured colors as the incidental lighting changes.

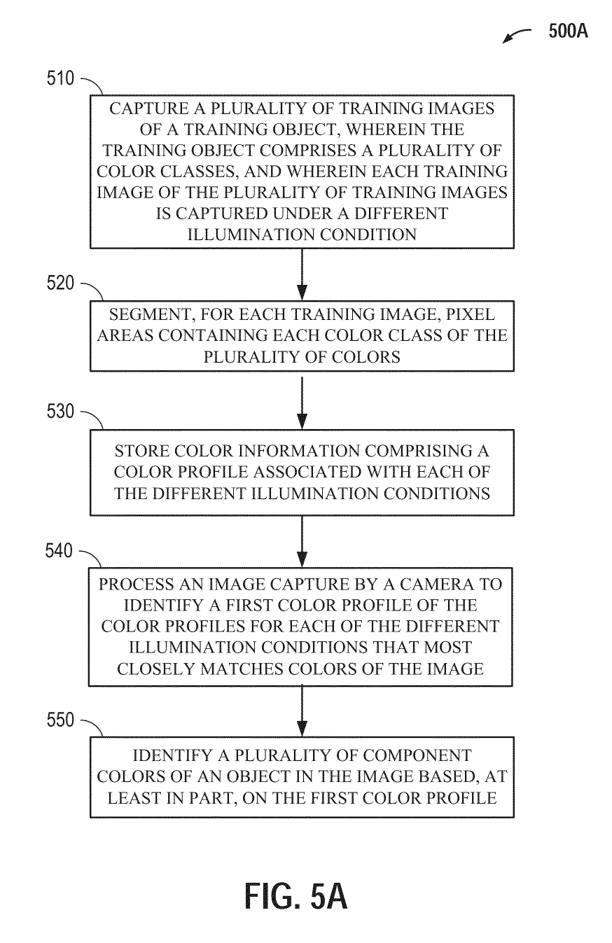

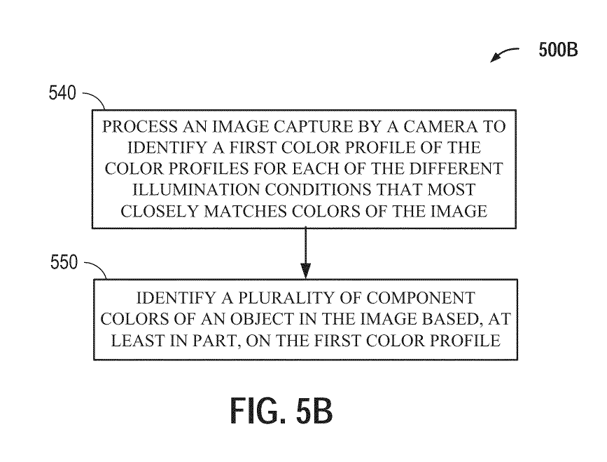

FIGS. 5A and 5B are flowcharts illustrating an exemplary method 500 for analyzing a target object with color classification as described herein. At block 510, a plurality of training images of a training object may be captured. The training object comprises a limited number of color components, and each training image is captured under different lighting or illumination conditions. A color class refers to the set of colors that is associated with a training object component of a particular color under different lighting conditions.

At block 520, pixel areas may be segmented based on color class for each image. At block 530, the color information may be saved as a color profile, such that each illumination condition is associated with a different color profile. The color profile may include all color appearances. Additionally or alternatively, a mean color of the colors for each color class may be used to represent the color class, and the color profiles may also include covariance measurements of colors across color classes. Therefore, each color profile may encode data related to how two or more component colors appear under a particular lighting condition. This finishes a training process as preparation for color recognition and classification.

At block 540, then, the image may be processed to identify a match to a particular color profile of the plurality of color profiles created during the training process. At block 550, component colors of the target object being detected may be identified based at least in part on the color profile that was selected. In particular, the color of each foreground pixel is classified into the color class of the chosen color profile that has the shortest distance to the color.

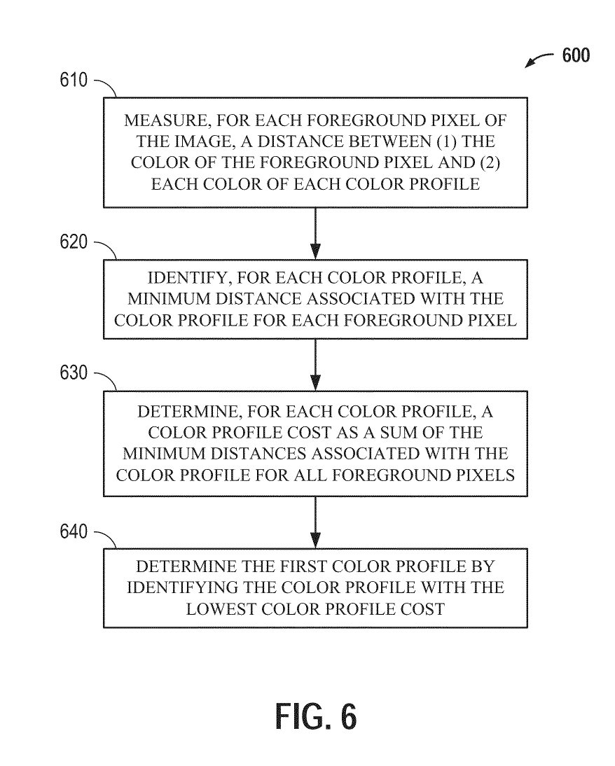

FIG. 6 is a flowchart illustrating an exemplary method 600 for determining a color profile from the training process that most closely matches a particular image. This uses the color measurement to identify a minimum distance between image pixel color values and profile colors as detailed in FIG. 4. In certain embodiments, the method 600 may be considered one method of implementing block 540 of FIGS. 5A and 5B.

At block 610, a distance between the color of each foreground pixel and each color of each color profile may be measured. For example, in FIG. 4, pixel color 420 may be associated with a particular foreground pixel, and distances 411 and 412 are two measured distances between foreground pixel color 420 and two of the colors 410a of color profile 405. This process of distance measurement is repeated between every foreground pixel and every color of every color profile. In alternative embodiments, the process of distance measurement may be based on measuring the distance between an average of related foreground pixel colors in a particular image and an average of a color class for each color class in each color profile. In further alternative embodiments, other statistical processing may be done on the pixel colors to limit the number of pixels used.

At block 620, a minimum distance between a particular foreground pixel and each color of a particular color profile may be identified. For example, in FIG. 4, distance 412 is the shortest distance between particular foreground pixel color 420 and the colors 410a of color profile 405. This would be repeated for every pixel and every color profile. For example, if the system of FIG. 4 includes three color profiles, then distance 412 would be a first minimum distance associated with foreground pixel color 420. Two additional distances would be determined, so that each color profile in the system would have one minimum distance determined for the particular foreground pixel color 420. This is done for every pixel. Continuing with this example, if the image included one thousand pixels, then there would be three thousand minimum distances calculated. This would be one thousand minimum distances associated with each color profile.

At block 630, a color profile cost may be determined for each color profile as a sum of the minimum distances associated with the color profile for each foreground pixel. Continuing again with the example above, there would be three color profile costs, one for each of the three color profiles. Each color profile cost would be the sum of the one thousand minimum distances identified for each color profile at block 620.

Then, at block 640, the lowest color profile cost may be determined, and the color profile with the lowest color profile cost may be selected as the color profile that most closely matches the colors of the image.

It should be appreciated that the operations of capturing images of the training object (e.g., block 510), of generating color profiles (e.g., blocks 520 and 530), of matching and utilizing color profiles (e.g., blocks 540, 550, and 610-640), and other related operations may be performed on the same device or on different devices. When the operations are performed on different devices, pertinent data may be transferred between the devices in a suitable manner. Whether any operation or combination of operations is performed on a particular device does not limit the disclosure.

As explained above, in some embodiments, the operations described herein may be applied to groups of pixels, such as groups of pixels that have been spatially segmented (pixel groups), instead of individual pixels. Each pixel group corresponding to a target object component can be identified as having a single object color. The object may then comprise a plurality of object colors, and the methods described above can be performed for each object color of the plurality of object colors. The object color for each component could be determined to be the average color of all of the pixels in the group of pixels that was segmented corresponding to the target object component.

Therefore, by creating and utilizing color profiles based on training images of a training object captured under different lighting conditions, colors of a target physical object containing the same limited number of known colors as those of the training object in an image may be correctly recognized and classified, regardless of the particular lighting condition under which the image of the target physical objects is captured.

Various implementations of exemplars-based color classification have been previously described in detail. It should be appreciated that the exemplars-based color classification application or system, as previously described, may be implemented as software, firmware, hardware, combinations thereof, etc. In one embodiment, the previous described functions may be implemented by one or more processors (e.g., processor(s) 110) of a device 100 to achieve the previously desired functions (e.g., the method operations of FIGS. 5A, 5B, and 6).

The teachings herein may be incorporated into (e.g., implemented within or performed by) a variety of apparatuses (e.g., devices). For example, one or more aspects taught herein may be incorporated into a general device, a desktop computer, a mobile computer, a mobile device, a phone (e.g., a cellular phone), a personal data assistant, a tablet, a laptop computer, a tablet, an entertainment device (e.g., a music or video device), a headset (e.g., headphones, an earpiece, etc.), a medical device (e.g., a biometric sensor, a heart rate monitor, a pedometer, an electrocardiography “EKG” device, etc.), a user I/O device, a computer, a server, a point-of-sale device, an entertainment device, a set-top box, a wearable device (e.g., watch, head mounted display, virtual reality glasses, etc.), an electronic device within an automobile, or any other suitable device.

In some aspects a wireless device may comprise an access device (e.g., a Wi-Fi access point) for a communication system. Such an access device may provide, for example, connectivity to another network through transceiver (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, Long Term Evolution (LTE), LTE Advanced, 4G, Code-Division Multiple Access (CDMA), Time Division Multiple Access (TDMA), Orthogonal Frequency Division Multiplexing (OFDM), Orthogonal Frequency Division Multiple Access (OFDMA), WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Erasable Programmable Read Only Memory (EPROM), Electrically Erasable Programmable Read Only Memory (EEPROM), registers, hard disk, a removable disk, a Compact Disc Read Only Memory (CD-ROM), or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for exemplars-based color classification, comprising:
processing an image captured by a camera to identify a first color profile that most closely matches colors of the image, wherein the first color profile is selected from a plurality of color profiles, each color profile encoding data related to how two or more component colors appear under a different lighting condition.

2. The method of claim 1, wherein the processing of the image comprises:
measuring, for each foreground pixel or foreground pixel group of the image, a distance between (1) a color of the foreground pixel or pixel group, and (2) each color of each color profile;
identifying, for each color profile, a minimum distance associated with the color profile for each foreground pixel or pixel group;
determining, for each color profile, a color profile cost as a sum of the minimum distances associated with the color profile for all the foreground pixels or all the foreground pixel groups; and
determining the first color profile by identifying a color profile with a lowest color profile cost.

3. The method of claim 1, wherein the processing of the image comprises:
segmenting an image to identify a plurality of object colors;
for each object color of the plurality of object colors, determining a distance between (1) the object color of the plurality of object colors, and (2) each color of each color profile;
identifying, for each color profile, a minimum distance associated with the color profile for each object color;
determining, for each color profile, a color profile cost as a sum of the minimum distances associated with the color profile for all the object colors; and
determining the first color profile by identifying a color profile with a lowest color profile cost.

4. The method of claim 3, wherein each object color of the plurality of object colors is selected as an average color for a target object component identified in the image.

5. The method of claim 1, further comprising:
identifying a plurality of component colors of a target object in the image based, at least in part, on the first color profile.

6. The method of claim 1, wherein the first color profile comprises a mean color for each color class.

7. The method of claim 1, wherein the first color profile comprises covariance measurements for colors across color classes.

8. An apparatus adapted for exemplars-based color classification, comprising:
a memory; and
a processor configured to:
process an image captured by a camera to identify a first color profile that most closely matches colors of the image, wherein the first color profile is selected from a plurality of color profiles, each color profile encoding data related to how two or more component colors appear under a different lighting condition.

9. The apparatus of claim 8, wherein the processor configured to process the image is further configured to:
measure, for each foreground pixel or foreground pixel group of the image, a distance between (1) a color of the foreground pixel or pixel group, and (2) each color of each color profile;
identify, for each color profile, a minimum distance associated with the color profile for each foreground pixel or pixel group;
determine, for each color profile, a color profile cost as a sum of the minimum distances associated with the color profile for all the foreground pixels or all the foreground pixel groups; and
determine the first color profile by identifying a color profile with a lowest color profile cost.

10. The apparatus of claim 8, wherein the processor configured to process the image is further configured to:
segment an image to identify a plurality of object colors;
for each object color of the plurality of object colors, determine a distance between (1) the object color of the plurality of object colors, and (2) each color of each color profile;
identify, for each color profile, a minimum distance associated with the color profile for each object color;
determine, for each color profile, a color profile cost as a sum of the minimum distances associated with the color profile for all the object colors; and
determine the first color profile by identifying a color profile with a lowest color profile cost.

11. The apparatus of claim 10, wherein each object color of the plurality of object colors is selected as an average color for a target object component identified in the image.

12. The apparatus of claim 8, wherein the processor is further configured to:
identify a plurality of component colors of a target object in the image based, at least in part, on the first color profile.

13. The apparatus of claim 8, wherein the first color profile comprises a mean color for each color class.

14. The apparatus of claim 8, wherein the first color profile comprises covariance measurements for colors across color classes.

15. An apparatus adapted for exemplars-based color classification, comprising:
means for processing an image captured by a camera to identify a first color profile that most closely matches colors of the image, wherein the first color profile is selected from a plurality of color profiles, each color profile encoding data related to how two or more component colors appear under a different lighting condition.

16. The apparatus of claim 15, wherein the means for processing the image further comprises:
means for measuring, for each foreground pixel or foreground pixel group of the image, a distance between (1) a color of the foreground pixel or pixel group, and (2) each color of each color profile;
means for identifying, for each color profile, a minimum distance associated with the color profile for each foreground pixel or pixel group;
means for determining, for each color profile, a color profile cost as a sum of the minimum distances associated with the color profile for all the foreground pixels or all the foreground pixel groups; and
means for determining the first color profile by identifying a color profile with a lowest color profile cost.

17. The apparatus of claim 15, wherein the means for processing the image further comprises:
means for segmenting an image to identify a plurality of object colors;
for each object color of the plurality of object colors, means for determining a distance between (1) the object color of the plurality of object colors, and (2) each color of each color profile;
means for identifying, for each color profile, a minimum distance associated with the color profile for each object color;
means for determining, for each color profile, a color profile cost as a sum of the minimum distances associated with the color profile for all the object colors; and
means for determining the first color profile by identifying a color profile with a lowest color profile cost.

18. The apparatus of claim 17, wherein each object color of the plurality of object colors is selected as an average color for a target object component identified in the image.

19. The apparatus of claim 15, further comprising:
means for identifying a plurality of component colors of a target object in the image based, at least in part, on the first color profile.

20. The apparatus of claim 15, wherein the first color profile comprises a mean color for each color class.

21. The apparatus of claim 15, wherein the first color profile comprises covariance measurements for colors across color classes.

22. A non-transitory computer-readable medium including code which, when executed by a processor, causes the processor to perform a method comprising:
processing an image captured by a camera to identify a first color profile that most closely matches colors of the image, wherein the first color profile is selected from a plurality of color profiles, each color profile encoding data related to how two or more component colors appear under a different lighting condition.

23. The non-transitory computer-readable medium of claim 22, wherein the code for processing the image further comprises code for: measuring, for each foreground pixel or foreground pixel group of the image, a distance between (1) a color of the foreground pixel or pixel group, and (2) each color of each color profile;
identifying, for each color profile, a minimum distance associated with the color profile for each foreground pixel or pixel group;
determining, for each color profile, a color profile cost as a sum of the minimum distances associated with the color profile for all the foreground pixels or all the foreground pixel groups; and
determining the first color profile by identifying a color profile with a lowest color profile cost.

24. The non-transitory computer-readable medium of claim 22, wherein the code for processing the image further comprises code for:
segmenting an image to identify a plurality of object colors;
for each object color of the plurality of object colors, determining a distance between (1) the object color of the plurality of object colors, and (2) each color of each color profile;
identifying, for each color profile, a minimum distance associated with the color profile for each object color;
determining, for each color profile, a color profile cost as a sum of the minimum distances associated with the color profile for all the object colors; and
determining the first color profile by identifying a color profile with a lowest color profile cost.

25. The non-transitory computer-readable medium of claim 24, wherein each object color of the plurality of object colors is selected as an average color for a target object component identified in the image.

26. The non-transitory computer-readable medium of claim 22, further comprising code for:
identifying a plurality of component colors of a target object in the image based, at least in part, on the first color profile.

27. The non-transitory computer-readable medium of claim 22, wherein the first color profile comprises a mean color for each color class.

28. The non-transitory computer-readable medium of claim 22, wherein the first color profile comprises covariance measurements for colors across color classes.
